(19) United States
(12) Patent Application Publication
(10) Pub. No.: US 2012/0034381 A1
(43) Pub. Date: Feb. 9, 2012

(54) METHOD FOR FORMING A PATTERNED COATING

(75) Inventor: CHUNG-PEI WANG, Tu-Cheng (TW)

(73) Assignee: HON HAI PRECISION INDUSTRY CO., LTD., Tu-Cheng (TW)

(21) Appl. No.: 12/915,062

(22) Filed: Oct. 29, 2010

(30) Foreign Application Priority Data
Aug. 9, 2010 (TW) 99126472

(51) Int. Cl. B05D 1/32

(52) U.S. Cl. 427/259

(57) ABSTRACT

A method for forming a coating on a plate-shaped workpiece is disclosed. In the method, a plate-shaped workpiece and a masking fixture are provided. The workpiece includes a surface including a coating region and a pattern region. The masking fixture includes a resilient liquid masking applicator having a groove. An outline shape of the groove conforms to the pattern region. The groove is filled with liquid masking material. The workpiece is pressed onto the liquid masking applicator with the pattern region aligned with the groove. The liquid masking material is solidified thereby the solidified liquid masking material is attached to the pattern region of the workpiece. A coating is formed on the coating region. The solidified liquid masking material is removed from the workpiece.

### BACKGROUND

1. Technical Field

The present disclosure relates to surface coating technology, and particularly, to a coating method for forming a patterned film layer on an outer surface of a workpiece.

2. Description of Related Art

Often graphics, such as logos, are formed on electronic products, such as computers, cell phones, and digital cameras by masking. However, edges of the masked regions may not be sharp because the liquid masking material used may seep under the edges of the masking material. Thus, a coating method is desired to overcome the limitations described.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the presentment method. Moreover, in the drawings, like reference numerals designate corresponding parts throughout the views.

FIG. 1 is an isometric view of a workpiece, a masking fixture provided in an embodiment of the present disclosure, the workpiece includes a coating region and a pattern region, the masking fixture includes a liquid masking applicator having a groove and a workpiece holders pivotably connected to the liquid masking applicator.

FIG. 2 shows the groove filled with liquid masking material.

FIG. 3 shows the workpiece holder pivoted to the liquid masking applicator.

FIG. 4 shows the ink after being solidified.

FIG. 5 shows a film layer formed on the workpiece.

FIG. 6 shows the workpiece after removing the masking material.

### DETAILED DESCRIPTION

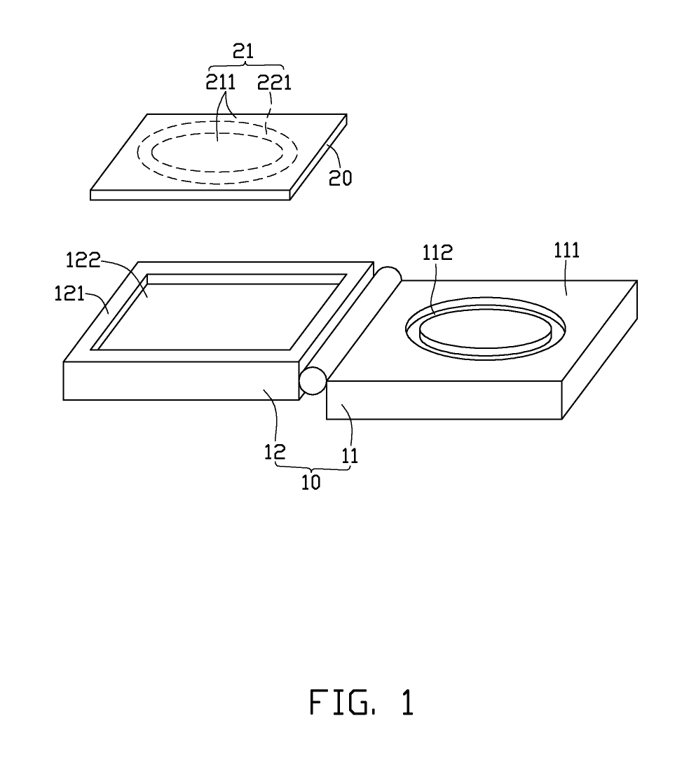

FIG. 1 shows a masking fixture 10 and a workpiece 20 provided in accordance with an exemplary embodiment. The workpiece 20 can be glass, silicon, quartz, carborundum, plastic or stainless steel. In the present embodiment, the workpiece 20 is a plastic plate used as part of an encasing for portable computer. The workpiece 20 includes an outer surface 21. The outer surface 21 includes a flat coating region 211 and a flat pattern region 221 for forming a graphic. In the present embodiment, as shown with dashed line in FIG. 1, the pattern region 221 is ring-shaped. The workpiece 20 is detachably fixed in the masking fixture 10.

The masking fixture 10 includes a liquid masking applicator 11 and a workpiece holder 12 pivotably connected to the liquid masking applicator 11. The liquid masking applicator 11 has a masking surface 111. A groove 112 having the same outline shape as the pattern region 221 is defined in the masking surface 111. The liquid masking applicator 11 is resilient, and is capable of deforming along a direction parallel to its height direction under a pressure and recovering its original shape when the pressure is released. The liquid masking applicator 11 can be made of shape memory alloy or shape memory polymer. For example, the liquid masking applicator 11 can be selected from a group consisting of titanium-nickel alloy, titanium-nickel-aluminium alloy, titanium-nickel-aluminium-zinc alloy, titanium-nickel-aluminum-zinc-copper alloy, copper-zinc-aluminium alloy, copper-zinc-calcium alloy, copper-aluminium-nickel alloy, copper-aluminium-boron alloy, and copper-zinc-silicon alloy, polyvinyl acetate based polymer, and polyurethane based polymer. The workpiece holder 12 includes a parting surface 121. An accommodating cavity 122 for accommodating the masking fixture 21 is defined in the parting surface 121. The accommodating cavity 122 has the same outline shape as the masking fixture 21. When the workpiece holder 12 is pivotably laminated on the liquid masking applicator 11, the pattern region 221 is superposed on the groove 112, and the groove 112 is gas-proof with the coating region 211.

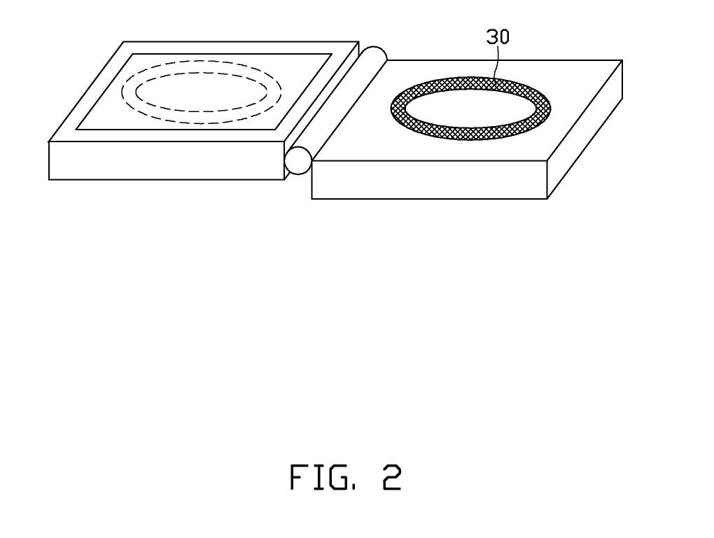

Referring to FIGS. 1 to 2, the groove 112 is filled with liquid masking material 30 using a typical ink injection process, a screen scratching process, or ink spraying process. In the present embodiment, the liquid masking material 30 is ink, and can be solidified by UV irradiation and easily stripped from the workpiece 20.

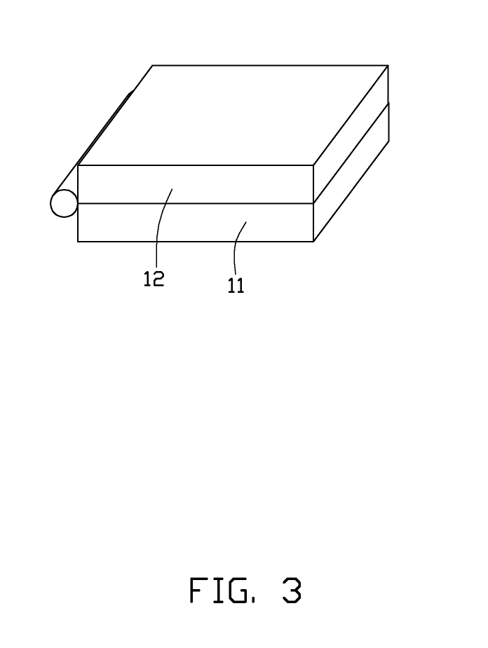

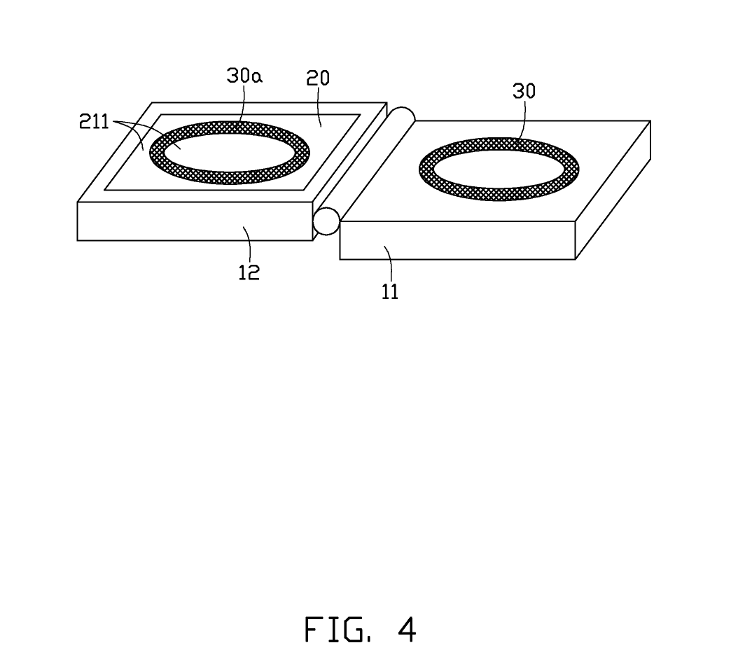

Referring to FIGS. 1 to 4, the workpiece holder 12 is rotated onto the liquid masking applicator 11, and a pressure is downwardly applied on the workpiece holder 12. It is understood that the pattern region 221 is superposed on the liquid masking material 30 in the groove 112, and the liquid masking applicator 11 resiliently abuts against the workpiece 20 and deforms downwardly. As a result, a portion of the ink 30a adheres to and coats the pattern region 221.

Referring to FIGS. 1 to 4, the workpiece holder 12 containing the workpiece 20 is quickly removed from the liquid masking applicator 11, and the ink 30a is then solidified. It is understood that the solidified ink 30a has the same dimension and configuration as the groove 112, and entirely covers the pattern region 221.

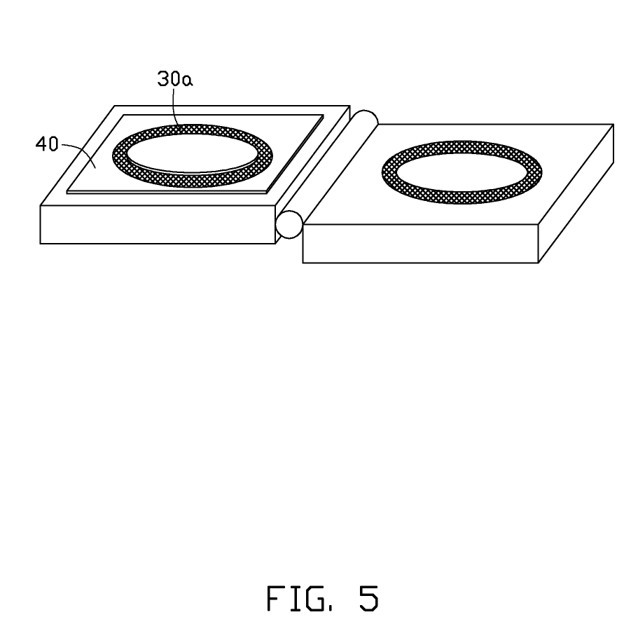

Referring to FIGS. 1 to 5, a film layer 40 is formed on the coating region 211 using a typical coating process, such as physical vapor deposition, chemical vapor deposition, laser assisted evaporation or ion polymerization deposition.

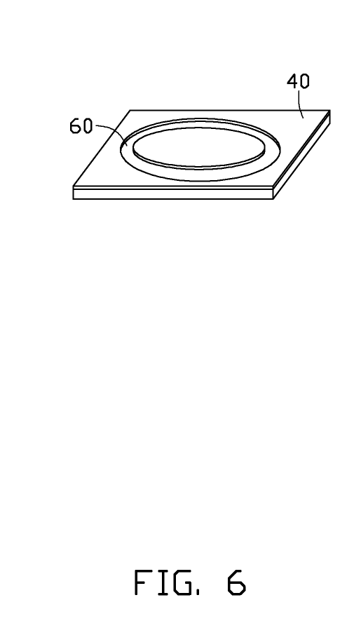

Referring to FIGS. 1, 5 and 6, the solidified ink 30a is removed, thereby forming a pattern 60 on the pattern region 221. The solidified ink 30a can be directly stripped from the workpiece 20 or dissolved with chemical agents. It is understood that the edge of the pattern 60 is consistent with the edge of the groove 112. Therefore, the edge of the pattern 60 is clear.

The embodiments described are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A method for forming a coating on a plate-shaped workpiece, comprising:
providing a plate-shaped workpiece, the workpiece comprising a surface including a coating region and a pattern region;
providing a masking fixture, the masking fixture comprising a resilient liquid masking applicator, the liquid masking applicator comprising a groove, an outline shape of the groove conforming to the pattern region;
filling the groove with liquid masking material;
pressing the workpiece onto the liquid masking applicator with the pattern region aligned with the groove;
solidifying the liquid masking material thereby the solidified liquid masking material attached to the pattern region of the workpiece;
forming a coating on the coating region; and
removing the solidified liquid masking material from the workpiece.

2. The method of claim 1, wherein the masking fixture further comprises a workpiece holder pivotably connected with the liquid masking applicator, the workpiece is mounted on the workpiece holder, and the workpiece holder is folded to cover the liquid masking applicator such that the pattern region is superposed on the liquid masking material in the groove and the liquid masking applicator resiliently abuts against the workpiece.

3. The method of claim 1, wherein the liquid masking applicator is made of shape memory alloy.

4. The method of claim 1, wherein the liquid masking applicator is made of shape memory polymer.

5. A method for forming a coating on a workpiece, comprising:
providing a workpiece, the workpiece comprising a flat surface consisting of a coating region and a pattern region;
providing a liquid masking applicator comprised of a shape memory material, the liquid masking applicator comprising a flat surface and a groove defined in the flat surface, an outline shape of the groove conforming to the pattern region;
filling the groove with liquid masking material;
pressing the workpiece onto the liquid masking applicator with the pattern region superposed on the liquid masking material in the groove;
solidifying the liquid masking material thereby the solidified liquid masking material attached to the pattern region of the workpiece;
forming a coating over the coating region; and
removing the solidified liquid masking material from the workpiece.
